(19) United States
(12) Patent Application Publication
(10) Pub. No.: US 2016/0349052 A1
(43) Pub. Date: Dec. 1, 2016

(54) Gyroscope sensor estimated from accelerometer and magnetometer

(71) Applicant: Behaviometrics AB, Lulea (SE)

(72) Inventors: Ingo Deutschmann, Merseburg (DE); Philip Lindblad, Lulea (SE)

(21) Appl. No.: 15/210,960

(22) Filed: Jul. 15, 2016

(51) Int. Cl. G01C 19/00; G01C 17/28; G01P 15/02

(52) U.S. Cl. CPC G01C 19/00; G01P 15/02; G01C 17/28

(57) ABSTRACT

Estimation of gyroscopic data on a mobile device is determined based on receiving a plurality of magnetometer-angle vectors from a magnetometer and receiving a plurality of accelerometer-angle vectors from an accelerometer. A plurality of matrices transform a coordinate system of the mobile device to an Earth coordinate system based on the magnetometer-angle vectors and the accelerometer-angle vectors. A plurality of estimated gyroscope vectors are then determined based on the plurality of matrices. A computer-implemented method), a program-code, and program-product, and devices for producing same are further disclosed herein.

### BACKGROUND OF THE INVENTION

1. Field of the Invention

The principles of the present disclosure describe a method, computer program, device and system for an estimated gyroscope sensor located in a mobile computer or communication device such as mobile phones.

### DEFINITIONS

A (classical) gyroscope is a spinning wheel or disc in which the axis of rotation is free to assume any orientation by itself based on the conservation of the angular momentum, useful for navigation application. Such a (classical) gyroscope is used for measuring or maintaining orientation to a fixed-star coordinate system such as for motion of satellites. In addition the afore-described classical gyroscope, modern integrated three-axis Microelectromechanical-Systems (MEMS)-gyroscopes determine orientation based on vibration instead of rotation. Only the later are typically used in portable electronic devices such as tablets, smartphones and smartwatches. The present disclosure Is directed towards a MEMS-type gyroscope. Thus, where “gyroscope” is used, this refers to a MEMS-type gyroscope or the equivalent.

A gyroscope is defined as a device which measures the rate of rotation such as in rad/s around a device coordinate system, i.e. device's x, y, and z axis. The gyroscope sensor's coordinate system is the same as the one used for an acceleration sensor. An acceleration sensor or accelerometer is a device which measure acceleration. Rotation is positive in the counter-clockwise direction; that is, an observer looking from some positive location on the x, y or z axis at a device positioned on the origin would report positive rotation if the device appeared to be rotating counter clockwise.

Mathematically, a general rotation of an object such as an orientation maintaining gyroscope vector placed in the three-dimensional space, is describable by a three-dimensional rotation-matrix operation. Physically caused by the inertia mass in general, only infinitesimal rotations about a point are possible and describable by Euler-angles, which built the terms of the elements of the rotation-matrix. Thus a finite rotation is the integral over all infinitesimal rotations, respectively a series of matrix operations. A suitable mathematical description of this problem based on four-componentic Hamilton-quaternions simplifies this problem to a series of quaternion-multiplications. By these products the evolution of real objects are describable physically.

2. Description of the Related Art

The patent document US2015260545 discloses a mobile phone having a hardware-based gyroscope and a method for calibrating same by selecting a putting of the device on one and the same plane table from time to time. A disadvantage of using a hardware-based gyroscope in a mobile phone is that it is complex and thus, costs more to produce and uses greater power consumption than a MEMS-gyroscope sensor.

Typically a low cost mobile phone, such as a smartphone, includes at least a simpler, less costly magnetometer and an accelerometer for roughly determining the orientation of the device with repsect to the earth coordinate system.

### SUMMARY OF THE INVENTION

Accordingly, it is an object of the present invention to provide besides a real MEMS-gyroscope sensor located in a mobile device only an estimated gyroscope sensor realized by software means.

The present invention overcomes the deficiencies and limitations discussed in the background section at least in part by providing innovative systems, devices, programs and methods for a gyroscope sensor estimated from accelerometer and magnetometer.

Method for estimation of gyroscopic data of a mobile device comprising calculation means, a clock, a magnetometer and an accelerometer, comprising the steps of:

a, b) sample for each time-stamp with the passing of time a plurality of magnetometer-angle vectors based on outputs produced by the magnetometer and accelerometer-angle vectors based on outputs produced by the accelerometer;

c) based on booth vectors calculate a plurality of matrices which transforms a device coordinate system to an earth coordinate system;

d) based on these matrices calculate a plurality of estimated gyroscope vectors.

It is a particular feature of the present invention that gyroscopic data like the orientation maintaining gyroscope vectors at least in one plane are only estimated by software means based on measured magnetometer data and accelerometer data available also in a low-cost mobile phone.

In some embodiments, the method uses at step c) a three-dimensional rotation matrix based on three orthonormal vectors derived from each of the accelerometer-angle vector and the magnetometer-angle vector, whereby the normalized accelerometer-angle vector becomes a row or column of the rotation matrix. Thus the horizon plane of the earth coordinate system is determined by the gravity as measured from the accelerometer and the North-direction by the earth magnetic field as measured from the magnetometer.

In some embodiments, the method uses at step c) a standardized function of the operating system (using Android SDK function getRotationMatrix( )) of the device. Thus the program-code generated is more efficient in size and run-time.

In some embodiments, the method uses at step d) a four-componentic quaternion vector for deriving the gyroscope vector from the rotation matrix. Thus the program-code generated is more efficient in size and run-time.

In some embodiments, the method comprises at the end a step:

e) calculating the derivative of the gyroscope vector by time. Thus an estimation for the rotation of the device related to the nearly star-fixed coordinate system of the earth is calculated.

In some embodiments, the method comprises at the end a step of storing the derivative of the gyroscope vector at a standardized rate-of-rotation vector. This estimation may be used by applications such as apps which need a gyroscope sensor. Thus a software-based emulator for a hardware-based gyroscope sensor is realized. It is noted that this gyroscope emulator needs an earth-magnetic field to work and is also limited in precision regarding classical rotating gyroscopes. These are no practically limitations for using it in a mobile computer or mobile phone such as a smartphone for applications such as:
a measurement of the number of rotations of a rotating object connected with the device,
services whose capturing the typically motion-behavior of the user carrying the device to measure his activity and
services using these collected behaviometric data for controlling purposes like authentication of the user based on his motion-behavior.

In some embodiments at least during a sequence of time collected behaviometric data comprise a flowing product of the quaternions calculated by quaternion-multiplication, optionally stored in the storage together with related flowing statistical data based on these product (sum, quadratic sum) for later statistical analysis like variance, mean square deviation and so one. Thus specific behaviometric data of an orientation development over time of the device relative to the Earth coordinate system respectively of an human carrier of this device moving along a motion path including a non vanishing rotation term is determined.

In some embodiments, the method uses a mean filter for at least one of the gyroscope vector and the derivation of the gyroscope vector. Thus a damping behavior is implemented for the gyroscope vector and the derivation of the gyroscope vector.

In some embodiments, the method uses at step a) a software implemented low pass filter to the angle-data measured of at least one of the magnetometer and the accelerometer. Thus noise distortion is limited and the inertia of a real physically measurement system including mass is better simulated too.

In some embodiments, the method uses at step a) a plausibility check for the absolute values of at least one of the magnetometer-angle vector and the accelerometer-angle vector. Optionally the absolute value of a valid magnetometer-angle vector is limited to an interval from 30 μT to 100 μT and the absolute value of a due accelerometer-angle vector is limited to an interval from 8 mŝ-2 to 12 mŝ-2. Thus a valid magnetometer-angle vector is limited to be a measurement only of the earth magnetic field which is approximately describable as a dipole field and a valid accelerometer-angle vector is limited to be a measurement only of the gravity acceleration which only occur when the device is not in linear accelerated motion as assumed for the deriving of the estimated gyroscope data.

There is further provided, in accordance with an embodiment of the present invention, a program-code runnable as a method as described above on at least one processor of a mobile device. Thus the innovative method may become an integrated part of an application or an operating system for mobile devices.

There is further provided, in accordance with an embodiment of the present invention, a program-product having:

a carrier for a program-code able to run on a mobile device as described above comprising a method as described above is running. Thus the innovative method may become an integrated part of a carrier of an application or an operating system for mobile devices.

There is further provided, in accordance with an embodiment of the present invention, a mobile device having:

one or more processors;

a clock;

an accelerometer sensor; and

a magnetometer sensor,

wherein at least on one processor a method as described above is running.

There is further provided, in accordance with an embodiment of the present invention, a system consisting of a mobile device able to run a method as described above and a program-product as described above. After loading the program-code to the mobile device done by the user and/or costumer and/or supplier the inventive gyroscope sensor will be available.

The novel features of the present invention are set forth in the appended claims. The invention itself, however, both its construction and its mode of operation, together with additional advantages and objects thereof, will be best understood from the following detailed description when read with reference to the accompanying drawings.

### BRIEF DESCRIPTION OF THE DRAWINGS

FIG. 1 shows a mobile device running a gyroscope application.

FIG. 2 shows a flow chart of steps taken in a method of an embodiment of the disclosed technology.

### DETAILED DESCRIPTION

The technology described herein includes a computer-implemented method for estimation of gyroscopic data of a mobile device, a program-code and program-product, such a device therefore and a system of booth.

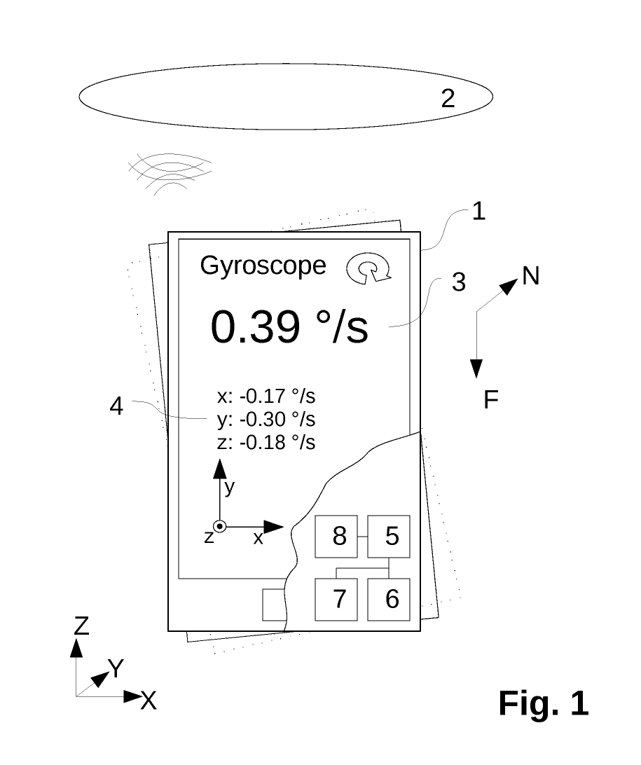

Regarding FIG. 1 a mobile device 1 is a bi-directional transceiver with input, memory storage, and network connectivity sometimes referred to as a “smartphone” which can run an operating system. An “operating system” is a series of instructions written into memory which can be excuted by a processor to effect hardware devices such as a display, speaker, network connection, and the like. An example is ‘Android’, as is known in the art. Via a network connect, the device is wirelessly connected to a network cloud 2, carried by a walking human person (not shown) moved and oriented anyway including rotational terms in the earth coordinate system X, Y, Z. The x, y, and z axes in the device coordinate system are defined in the same way as the accelerometer 6. The earth coordinate system X, Y, Z is defined as a direct orthonormal basis. This coordinate system has the following characteristics:
X is defined as the vector product Y×Z. It is tangential to the ground at the device's current location and points approximately East.
Y is tangential to the ground at the device's current location and points toward the geomagnetic North Pole.
Z points toward the sky and is perpendicular to the ground plane.

At the device 1 a gyroscope application 3 is running and displays an estimated gyroscope vector 4 of rotation and the related three rate-of-rotation values x, y, z, each for the angle velocity about the three axis x, y and z of the device coordinate system. Inside the device 1 a processor 5 formed out as microcontroller with calculation-unit and clock is readably connected with a MEMS-accelerometer 6 measuring a force F equal the gravity of the earth and a MEMS-magnetometer 7 measuring the earth-magnetic field lying in the plane with the North-direction N and readable/writable with a storage 8 including captured estimated gyroscope date with the passing of time.

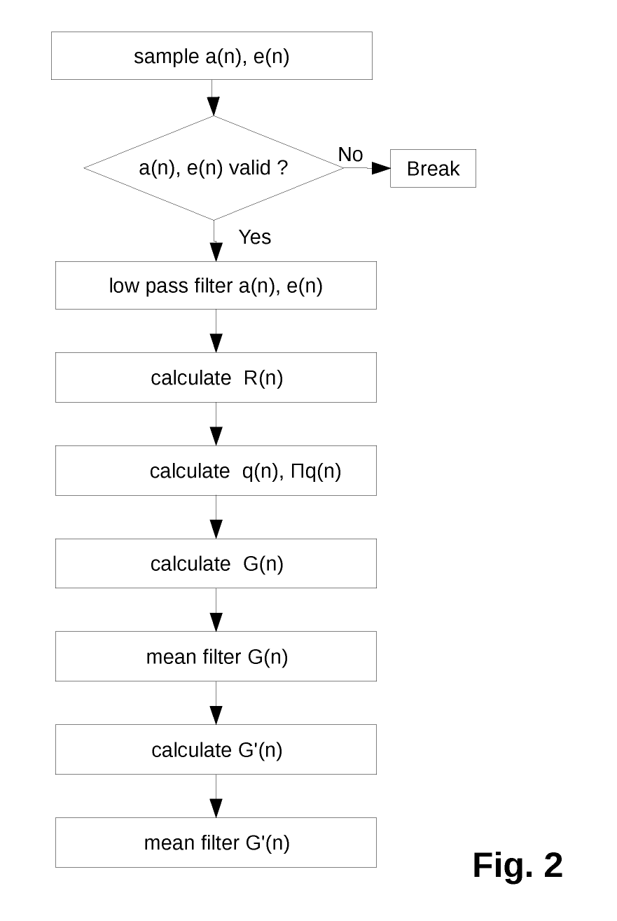

Regarding FIG. 2 a flow chart of the method for estimation of gyroscopic data is shown. When the gyroscope application is running for each time-step n given by the clock 100 times a second with a dT=10 ms between them the following steps were executed:
a, b) A magnetometer-angle vector e(n) based on outputs produced by the magnetometer 7 (FIG. 1) and an accelerometer-angle vector a(n) based on outputs produced by the accelerometer 6 (FIG. 1) are sampled, whereby each of the magnetometer-angle vector e(n) and the accelerometer-angle vector a(n) passes at first a plausibility check and later a low band filter.

The plausibility check calculates the absolute values of booth of the magnetometer-angle vector e(n) and the accelerometer-angle vector a(n). For this the triangle norm using the formula

∥s∥=|sₓ|+|s_{y}|+|s_{z}|

simpler computable than Euclids-norm is used to derive an absolute value, whereby the absolute value of a valid magnetometer-angle vector e(n) is limited to an interval from 30 μT to 100 μT and the absolute value of a due accelerometer-angle vector a(n) is limited to an interval from 8 mŝ-2 to 12 mŝ-2. If the plausibility check is failed the method breaks because the physically assumption are not given. The low pass filter is applied to each sensor using the following formula

s(n)_{filtered}=α*x(n)+(1−α)s(n−1)_{filtered}

Where x(n) is the raw sensor data and s(n) the filtered data (alpha is constant <1).
b) Based on booth filtered vectors e(n), a(n) a rotation matrix R(n) is calculated which transforms the device coordinate system to the earth coordinate system using the following formulas.

$$h = e \times a$$

$$a = \frac{a}{‖ a ‖}$$

$$h = \frac{h}{‖ h ‖}$$

$$m = a \times h$$

$$R = \begin{matrix}hx & hy & hz \\ mx & my & mz \\ ax & ay & az\end{matrix}$$

This is programmed especially for the operating system “Android” running on the device 1 (FIG. 1) by calling the ‘Android’ Standard-Development-Kid) SDK function getRotationMatrix( )
c) Based on the rotation matrix R(n) calculate the estimated gyroscope vector G(n). For this the rotation matrix R(n) is transformed into a four-componentic quaternion q. This is based mathematically on the fact that the three elements of the gyroscope vector G(n) are equal to the last three components p of a unit quaternion q=(cos(θ/2), x*sin(θ/2), y*sin(θ/2), z*sin(θ/2)). The elements of the gyroscope vector G(n) are unitless. This is programmed especially for the operating system “Android” running on the device 1 (FIG. 1) by calling the following function written in C programming language:

private float[ ] rotationMatrix2quaternion(float[ ] R){

float[ ] quaternion = new float[4];
quaternion[3] = 0.5f * (float) Math.sqrt(1 + R[0] + R[4] + R[8]);
quaternion[0] = 0.25f / quaternion[3] * (R[7] − R[5]);
quaternion[1] = 0.25f / quaternion[3] * (R[2] − R[6]);
quaternion[2] = 0.25f / quaternion[3] * (R[3] − R[1]);
return quaternion;

}

At least during a sequence of time a flowing product [symbol] (n) of the quaternions is calculated by quaternion-multiplication [symbol] (n)= [symbol] (n−1)*q(n) and stored in the storage 8 (FIG. 1) together with related flowing statistical data based on these product i.e. their sum and quadratic sum for later statistical analysis like variance and mean square deviation. Convert the unitless quaternion vector q into the three-dimensional gyroscope vector p. This can be programmed especially for the operating system “Android” running on the device 1 (FIG. 1) by calling the following function written in C programming language:

private float[ ] quaternion2gyro(float[ ] quaternion, float dT){

float cosThetaOverTwo = quaternion[3];
float thetaOverTwo = (float) Math.acos(cosThetaOverTwo);
float omegaMagnitude = thetaOverTwo / dT * 2.0f;
float sinThetaOverTwo = (float) Math.sin(thetaOverTwo);
float axisX = quaternion[0] / sinThetaOverTwo;
float axisY = quaternion[1] / sinThetaOverTwo;
float axisZ = quaternion[2] / sinThetaOverTwo;
axisX *= omegaMagnitude;
axisY *= omegaMagnitude;
axisZ *= omegaMagnitude;
return new float[ ]{axisX, axisY, axisZ};

}

This unitless p(n) values are smoothed by a mean-filter using the formula:

$$G ( n ) = \frac{1}{20} {\sum }_{i = 0}^{19} p ( n - i )$$

The filtered G(n) are the elements of the estimated gyroscope vector, where each element of p(n) is in [rad].
d) Take the derivative of G(n) by time using the formula:

G′(n)=G(n)−G(n−1)

and smooth the G′(n) by running a mean filter for using the formula:

$$E ( n ) = \frac{1}{20} {\sum }_{i = 0}^{19} {G}^{′} ( n - i )$$

The filtered E(n) are the rate-of-rotation vector 4 (FIG. 1) for each axis x, y, z of the derive coordination system. The G(n) and the G′(n) values were stored at a standardized rate-of-rotation vector of the operating system to emulate a software-based gyroscope sensor and also stored including the time-stamp at the storage 8 for later usage by different applications from third parties using the fact that the stored data are also behaviometric data possibly related with the movement of the user whose is/was carrying the devise 1 (FIG. 1) at least time by time recently and in the past.

Although the present invention was shown and described with references to the preferred embodiments, these are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

1. A method for estimation of gyroscopic data of a mobile device, said mobile devices comprising a processor, a clock, a magnetometer, and an accelerometer, comprising the steps of:
a) receiving a plurality of magnetometer-angle vectors (e(n)) based on output of the magnetometer;
b) receiving a plurality of accelerometer-angle vectors (a(n)) based on outputs produced by the accelerometer;
c) determining a plurality of matrices which transforms a coordinate system of said mobile device to an Earth coordinate system based on said plurality of said magnetometer-angle vectors and said accelerometer-angle vectors;
d) calculating a plurality of estimated gyroscope vectors (G(n)) based on said plurality of matrices.

2. The method of claim 1, wherein said plurality of said matrices comprise a three-dimensional rotation matrix (R(n)) based on three orthonormal vectors derived from each of at least one said accelerometer-angle vector (a(n)) of said plurality thereof and at least one said magnetometer-angle vector (e(n)) of said plurality thereof, whereby a normalized accelerometer-angle vector (a(n)) becomes a row or column of the rotation matrix (R(n)).

3. The method of claim 1, wherein said method uses at step b) a standardized function of the operating system of the device (1).

3. The method of claim 1, wherein said method uses at step c) a four-componentic quaternion (q(n) for deriving the gyroscope vector (G(n)) from the rotation matrix.

4. The method of claim 1, wherein after said step of calculating said plurality of said determined gyroscopic vectors, a further step of calculating the derivative of the gyroscope vector (G(n)) by time Is carried out.

5. The method of claim 4, wherein said derivative of the gyroscope vectors (G(n)) is at a standardized rate-of-rotation vector (E(n)).

6. The method of claim 3, wherein at least during a sequence of time collected behaviometric data comprise a flowing product of the quaternions calculated by quaternion-multiplication.

7. The method of claim 6, wherein, stored in the storage together with related flowing statistical data based on these product for later statistical analysis.

8. The method of claim 1, wherein said method further comprises executing a mean filter for at least one of the gyroscope vector (G(n)) and the derivation (E(n)) of the gyroscope vector.

9. The method of claim 1, further comprising a step of executing code using said processor to perform low pass filtering on outputs of said magnetometer and said accelerometer.

10. The method of claim 1, wherein said method comprises a further step of conducting a plausibility check for absolute values of at least one of said magnetometer-angle vector (e(n)) and said accelerometer-angle vector (a(n)).

11. The method of claim 10, wherein the plausibility of the absolute values of said magnetometer-angle vector (e(n)) is limited to an interval from 30 μT to 100 μT and the absolute value of said accelerometer-angle vector (a(n)) is limited to an interval from 8 mŝ-2 to 12 mŝ-2 and said plausibility check is conducted for said magnetometer-angle vector (e(n)) and said accelerometer-angle vector (a(n)).

12. A program-product, comprising a carrier for a program-code able to run a method of claim 1 on said mobile device.

13. A mobile device, comprising:
a processor;
a clock;
an accelerometer; and
a magnetometer,
wherein said processor carries out said method of claim 1.

14. A system consisting of a mobile device able to run a method for estimation of gyroscopic data of said mobile device, comprising a processor, a clock, a magnetometer, and an accelerometer, doing the steps of:
a) receiving a plurality of magnetometer-angle vectors (e(n)) based on output of the magnetometer;
b) receiving a plurality of accelerometer-angle vectors (a(n)) based on outputs produced by the accelerometer;
c) determining a plurality of matrices which transforms a coordinate system of said mobile device to an Earth coordinate system based on said plurality of said magnetometer-angle vectors and said accelerometer-angle vectors;
d) calculating a plurality of estimated gyroscope vectors (G(n)) based on said plurality of matrices;
and a program-product, comprising a carrier for a program-code able to run said method on said mobile device.
